(19) United States
(12) Patent Application Publication
(10) Pub. No.: US 2023/0338966 A1
(43) Pub. Date: Oct. 26, 2023

(54) SYSTEMS AND METHODS FOR CRYOGENIC SEPARATION OF PLANT

(71) Applicant: Cryomass LLC, Englewood, CO (US)

(72) Inventors: Matthew John Armstrong, Anchorage, AK (US); Christopher Barone, Ranchos Palos Verdes, CA (US)

(21) Appl. No.: 18/074,941

(22) PCT Filed: Jun. 4, 2021
(86) PCT No.: PCT/US21/35962

§ 371 Date: Dec. 5, 2022

Related U.S. Application Data
(60) Provisional application No. 63/034,957, filed on Jun. 4, 2020.

(51) Int. Cl. B02C 23/20; F25B 19/00

(52) U.S. Cl. CPC B02C 23/20; F25B 19/005

(57) ABSTRACT

A system for cryogenic separation of plant material includes a hopper for receiving the plant material. A shredder mill grinds the plant material received in the hopper. A first agitation vessel receives the plant material from the shredder mill and performs a first separation process with cryogenic fluid on the plant material. A second agitation vessel receives the plant material from the first agitation vessel and performs a second separation process on the plant material. A containment vessel receives the plant material from the second agitation vessel.

### CROSS-REFERENCED TO RELATED APPLICATION

This application is a United States National Phase Application of PCT/US2021/035962, filed Jun. 4, 2021, which claims priority to U.S. Provisional Application No. 63/034,957, filed on Jun. 4, 2020.

### FIELD

This application relates in general to separating plant particulates and, in particular, to a system and method for cryogenic separation of plant material.

### BACKGROUND

Plant components are widely popular across different industries for use in cosmetics, perfumes, drug compositions, food, crafts, and fabrics. To obtain the necessary components, plant material is processed to separate those components of the plant from other parts not needed. For instance, many pharmaceutical companies utilize pharmacologically active extracts that are separated from plant materials. However, separation processes are carefully selected and performed to ensure purity and high yields of the desired component.

For example, indumentums of a plant often include the highest concentration of certain plant compounds, which are often used in drug manufacture. Indumentums are extremely fragile due to their resinous nature and can rupture during mechanical separation. Thus, much of the compounds can be lost due to rupture during conventional methods for extraction, such as solvent extractions and mechanical extractions.

Solvent separations require solvents, such as hydrocarbon, alcohol, or carbon dioxide, which can dissolve chemical components of a plant, such that indumentums are not physically preserved. The solvents eventually evaporate and only the chemical components are left together, without separation from other components.

Conventional processes for mechanical separation can be performed with or without an aqueous solution. Mechanical separation performed without an aqueous solution, such as water, utilizes a system of screens to separate plant components by size, but such process can cause the fragile indumentums to rupture. Mechanical separation can also require a matrix, such as water, which can alter the composition of the extracted plant component or a ratio of the desired plant components. Such process can include separation achieved through physical agitation in a reduced temperature aquatic matrix, followed by filtration through sequential layers of varied mesh, and finally drying of the separated plant component.

However, due to the aqueous nature of the separation, the minimum temperature for use in the extraction process is limited, which in turn limits the ability to preserve any volatile compounds. Also, preservation can be inhibited by retention of the plant components in the aqueous filtrate. Further, use of water as a solvent during the separation process and subsequent high moisture content of the plant particulates during and after separation can lead to waterborne pathogens, microbial growth, and other types of possible contamination.

### SUMMARY

Extraction of plant materials should be efficiently performed to prevent breakage or rupture of fragile components, such as indumentums, and ensure sufficiently pure components, free of contamination. Solvent extractions utilize solvents that dissolve chemical components of a plant, preventing preservations of certain components, such as indumentums, while most conventional mechanical extraction processes utilize aqueous solutions, which can lead to waterborne pathogens or microbial growth. Accordingly, a non-aqueous extraction process helps prevent any contamination due to water and includes filling a vessel with cryogenic fluid, placing one or more plants for processing into the vessel, providing agitation to the plants, and pulling the plant particulates remaining in the vessel out, while opening a valve in the vessel to release those components separated from the matrix.

One embodiment provides a system and method for cryogenic separation of plant material. A vessel is filled with cryogenic fluid having a temperature at or less than −150 degrees Celsius. Plant material is placed into the vessel via a basket and agitation is provided to the plant material in the vessel for a predetermined time period. Upon completion of the time period, the basket having at least a portion of the plant material is removed from the vessel. Plant particulates separated from the plant material during the agitation settle to the bottom of the vessel. The vessel is drained of the cryogenic fluid, including plant particulates separated from the plant material.

A system for cryogenic separation of plant material according to an example of this disclosure includes a hopper for receiving the plant material. A shredder mill grinds the plant material received in the hopper. A first agitation vessel receives the plant material from the shredder mill and performs a first separation process with cryogenic fluid on the plant material. A second agitation vessel receives the plant material from the first agitation vessel and performs a second separation process on the plant material. A containment vessel receives the plant material from the second agitation vessel.

In a further example of the foregoing, the hopper includes a spray bar for spraying cryogenic fluid on the plant material.

In a further example of any of the foregoing, the containment vessel includes a containment basket for containing plant particulates of the plant material.

In a further example of any of the foregoing, the system includes one or more fluid paths between the containment vessel and first agitation vessel for recirculating the cryogenic fluid.

In a further example of any of the foregoing, a fluid path transfers plant material and cryogenic fluid from the first agitation vessel to containment vessel.

In a further example of any of the foregoing, a second fluid path transfers cryogenic fluid from the containment vessel to the first agitation vessel.

In a further example of any of the foregoing, a third fluid path transfers cryogenic fluid from the containment vessel to the second agitation vessel

In a further example of any of the foregoing, at least one spray bar within the first agitation vessel sprays cryogenic fluid on the plant material.

In a further example of any of the foregoing, at least one spray bar is elongated vertically with respect to the first agitation vessel.

In a further example of any of the foregoing, at least one spray bar extends along a central axis, and the at least one spray bar is rotatable relative to the central axis to vary spray direction.

In a further example of any of the foregoing, at least one spray bar is rotatable from a first position oriented to spray toward the center of the vessel to a second position oriented to spray at an inner wall of the vessel.

In a further example of any of the foregoing, at least one spray bar is rotatable from a third position oriented to spray in a direction substantially tangentially along the inner wall to the second position.

In a further example of any of the foregoing, at least one spray bar is rotatable from a first position oriented to spray in a direction along an inner wall of the vessel to a second position oriented to spray at the inner wall.

In a further example of any of the foregoing, at least one spray bar includes a plurality of spray bars.

In a further example of any of the foregoing, the fluid path is provided by stainless steel piping.

In a further example of any of the foregoing, the stainless steel piping is 316L stainless steel piping.

A method for cryogenic separation of plant material according to an example of this disclosure includes placing plant material into a hopper and grinding the plant material in a shredder mill. The plant material is transferred from the shredder mill to a first agitation vessel. A first separation process with cryogenic fluid is performed on the plant material in the first agitation vessel. The plant material is transferred from the first agitation vessel to a second agitation vessel. A second separation process is performed with cryogenic fluid on the plant material in the second agitation vessel.

In a further example of the foregoing, the first separation process includes spraying the plant material with cryogenic fluid via at least one spray bar.

In a further example of any of the foregoing, at least one spray bar is elongated vertically with respect to the first agitation vessel.

In a further example of any of the foregoing, at least one spray bar extends along a central axis. At least one spray bar is rotatable relative to the central axis to vary spray direction, and the first separation process includes rotating the at least one spray bar.

These and other features may be best understood from the following specification and drawings, the following of which is a brief description.

### BRIEF DESCRIPTION OF THE DRAWINGS

FIG. 1 is an interior view of an example separation system for separating plant material.

FIG. 2 is a flow diagram showing a method for separating plant material using the separation system of FIG. 1.

FIG. 3 schematically illustrates another example separation system.

FIG. 4 illustrates an example agitation vessel.

### DETAILED DESCRIPTION

Conventionally, some plant separation methods require the use of aqueous solutions. However, the use of such aqueous solutions can lead to contamination, such as waterborne pathogens and microbial growth. To prevent contamination from occurring, a non-aqueous separation process is utilized.

Applicant has recognized that a need remains for a process that provides separated plant components, while maintaining a consistent chemical preservation of the desired components. Additionally, the process should be effective to result in high yields of the desired separated component, while ensuring that such components are sufficiently pure and free of contamination.

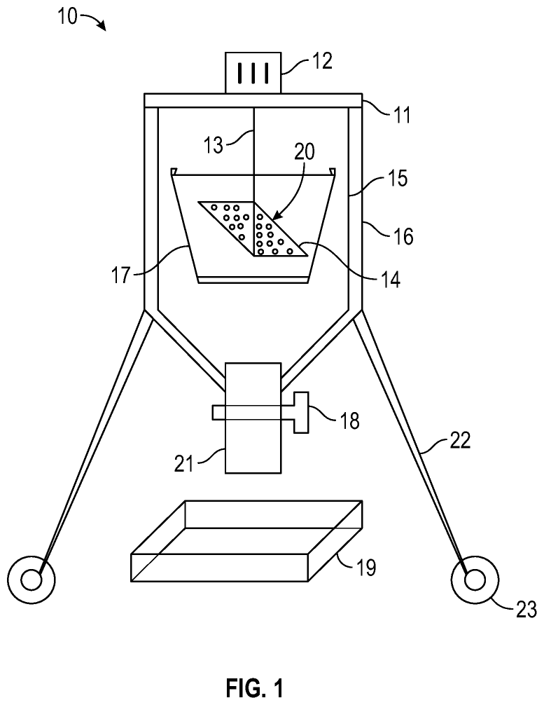

FIG. 1 is a side view of a separation system 10 for separating plant material, in accordance with one embodiment. The separation system 10 includes a separation vessel 15, an agitator 20, at least one perforated basket 17, and a collection tray 19 to collect plant particulates separated from the plant material. Hereinafter, the terms “particulate” and “component” are used interchangeably with the same intended meaning, unless otherwise indicated.

The separation vessel 15 can have a conical shape with an opening on a top end that extends through a bottom end, which tapers into a stem 21 with a valve 18 to regulate the flow of fluid through the vessel. The vessel 15 can be made from material, such as food grade stainless steel, as well as other types of material. At a minimum, the material should be able to withstand extended contact with cryogenic fluids, such as those fluids with a temperature of −150 degrees Celsius or less.

The vessel 15 can be supported and raised via three or more support legs 22. The length and number of the legs 22 can be dependent on the size of the vessel 15 and placement of the vessel 15. For example, when the vessel 15 is sized to be placed on a table, the legs 22 will likely be shorter than when the vessel 15 is larger and is placed on the floor. Additionally, as the vessel size increases, the size and number of the legs 22 can also increase. Each of the legs 22 can have a shape, such as conical or square, and include a rolling caster 23 with a lock to allow easy movement of the vessel. Other shapes of the vessel and legs are possible.

In one embodiment, a jacket 16 can be placed over at least a portion of the vessel 15 to control a temperature inside the vessel 15 and prevent excessive condensation on the surface of the vessel. The vessel jacket 16 can be filled with an insulator, such as foam or voided with a vacuum. In one embodiment, the vacuum can range from 759 torr down to a minimum pressure rating assigned to the vessel. For example, a stainless steel vessel has a lower minimum pressure rating than a vessel made from food grade polymeric material.

One or more baskets 17 can be used within the vessel 15 by placing the baskets 17 through the opening. When multiple baskets are used, the baskets 17 can be nested together within the vessel 15 to increase a selectivity of the separation that will occur. The different baskets may have different diameters of mesh as to isolate plant particulates of varying size. For example, the more baskets used, the more likely the desired component is, by itself, separated from the remaining plant material. Each basket 17 can be made from a mesh material, such as stainless steel, with a diameter of open space, between grids of the mesh material, between 0.1-10,000 microns. The diameter of the mesh material and the number of baskets used can be based on the desired plant material to be processed or the desired plant component to be separated, as well as a desired level of separation. Additionally, a width of the mesh grids can be in the range of 25-400 um; however, in one embodiment a size of 305 um is used. Other sizes of the mesh diameter and grid width are possible, as well as other types of mesh material. At a minimum, the material for the basket 17 should be able to withstand temperatures at or below −150 degrees Celsius. A shape of the baskets can be tapered on a bottom end and include at least one handle or attachment point for use during insertion and removal of the basket from the vessel.

During the separation process, a lid 11 can be placed over the top opening of the vessel 15. The agitator 20 can be affixed to the bottom side of the lid 11, facing inside of the vessel, and can be powered manually or via a motor 12, which can be affixed to a top side of the lid 11. The agitator 20 can include a shaft 13 that extends from the bottom side of the lid and extends downward. One or more paddles 14 are affixed on one end of the shaft 13, opposite the lid 11. The paddles 14 are each shaped as one of a rectangle, square, triangle, oval, or trapezoid, however, other paddle shapes are possible. The paddles 14 can have the same shape and size, or different shapes and sizes. Additionally, in one embodiment, one or more of the paddles can be perforated with holes of varying circumference.

A length of the agitator shaft 13 is dependent on a depth of the vessel 15 and any baskets 17 placed into the vessel. Additionally, the paddle shape and size is dependent on a diameter of the inside of the vessel. At a minimum, the paddles 14 should conformably fit within the vessel and any baskets 17 placed within the vessel. Preferably, the paddles extend from the shaft to a point just short of an inside wall of the basket to prevent obstruction of the paddles during agitation.

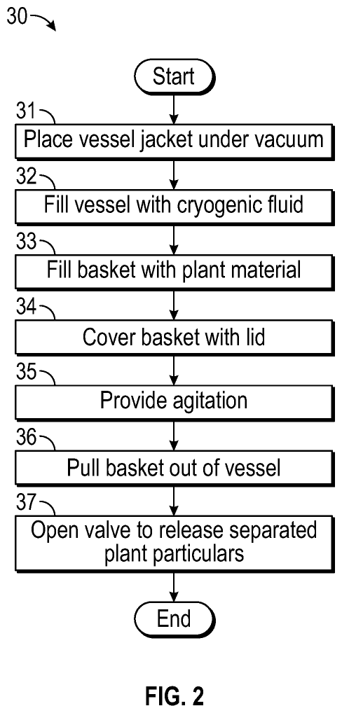

The agitator facilitates separation of plant material placed into the vessel. FIG. 2 is a flow diagram showing a method for separating plant material via the separation system of FIG. 1. The jacket surrounding at least a portion of the vessel is either filled with an insulator or voided with a vacuum. In one embodiment, the jacket is placed (block 31) under a vacuum in the range of 759 torr down to the minimum pressure rating of the vessel. Next, upon ensuring the valve is in a closed position, the vessel is filled (block 32) with cryogenic fluid to a predefined mark. In one embodiment, the fill mark can be determined to prevent spilling of the cryogenic fluid out of the vessel due to displacement by a basket and plant material.

The cryogenic fluid described herein can include helium, hydrogen, nitrogen, neon, air, oxygen, fluorine, argon, methane, or a combination of such fluids. Additionally, other types of cryogenic fluids are possible. In some examples, at a minimum, the cryogenic fluid should be at or below −150 degrees Celsius. In one embodiment, liquid nitrogen is used.

Plant material is placed (block 33) in at least one basket that is lowered (block 34) into the cryogenic fluid though the opening in the vessel. The plant material can include whole plants, flowers, trimmings, leaves, stalks, roots, or stems, as well as any other plant parts. An amount of the plant material to be placed in the vessel is dependent on a size of the vessel. In one embodiment, up to 3,000 grams of plant material can be processed at a single time; however, other amounts are possible. Prior to placement in the basket, the plant material is frozen and subsequently pulverized. In one embodiment, the plant material is recently harvested to prevent drying of the plant and maximize preservation of desired plant components and other chemical compounds within the plant material.

Once the basket is positioned in the vessel, the lid is placed on the vessel and the agitator provides (block 35) agitation to the plant material by spinning the paddles within the basket, which results in separation of particular components from the plant material. The agitation can occur manually or via a motor. The environment inside the vessel, provided by the cryogenic liquid, helps solidify certain plant particulates, such as indumentums, and makes those particulates easily separable from the plant material, such as by reducing rupture due to the agitation and force of separation. Additional baskets with varying sizes of mesh can be used to separate different plant components by size.

The agitation should be performed for a time period long enough to sufficiently separate a desired component, such as between one and 60 minutes, and at a speed fast enough to ensure full agitation of the plant material within the cryogenic fluid. In one embodiment, the agitation time should be between 10 and 15 minutes.

Upon completion of the agitation, the lid is removed and the basket, with any remaining plant material, is raised (block 36) above the cryogenic fluid for draining. The plant particulates can be allowed to settle to the bottom of the vessel, in or near the tapered stem area above the valve, over the course of 1-30 minutes. However, other times are possible, such as over 30 minutes. The valve is then moved (block 37) to an open position to allow the separated plant particulate to exit the vessel onto the collection tray via the cryogenic fluid. In one embodiment, the valve can be toggled between open and close positions to release a minimum volume of cryogenic fluid to fully empty the separated plant particulate. Once clean fluid flows, the valve is closed. The separated plant particulate, upon removal from the vessel, can have a water content up to 90% and can be dried to a desired concentration using, for example, a freeze dryer. However, other drying methods are possible.

An amount of drying can be based on the separated plant particulate. In one embodiment, drying should occur until the plant particulate has a moisture content of less than 10%. Additionally, refinement of the separated plant particulate can be performed prior to or after drying. Refinement can occur via by passing the separated plant particulate though additional sieves or screens to isolate target plant components, performing a solvent extraction of the separated plant particulate, steaming the plant particulate, or performing a vacuum distillation. The separation process can be repeated using the same cryogenic fluid with new plant material.

Once separations have been completed, the vessel and all other parts should be cleaned. Due to the vessel design, cleaning is easily performed and can reduce the time necessary between the separation of different plant materials, which increases the amount of plant material processed during a particular time period. Also, the lack of pumps and tubing, as well as the lack of water, helps prevent the introduction of microbial contamination.

In one example, cannabis has thermolabile compounds, which are most highly concentrated in the indumentums of the cannabis plant. As part of the separation process, the cannabis plants are frozen, pulverized, and placed in a basket with a mesh grid having a size of 305 um. The basket and cannabis plants are lowered into the cryogenic fluid. For instance, 3,000 g of cannabis can be processed at a time. Manual agitation can be performed for 12 minutes, after which the basket is removed from the cryogenic fluid and drained. The valve is released and the indumentums, which were separated from the cannabis plant during agitation, are released from the vessel. The indumentums are then placed in a freeze dryer for 18 hours.

In a further embodiment, a recirculating pump can be installed on a bottom of the vessel. The recirculating pump can pump liquid from the bottom of the vessel to the top of the vessel, such as to a predefined mark or liquid line inside the vessel. Recirculating the liquid in the vessel creates a circular downward flow, which facilitates filtration.

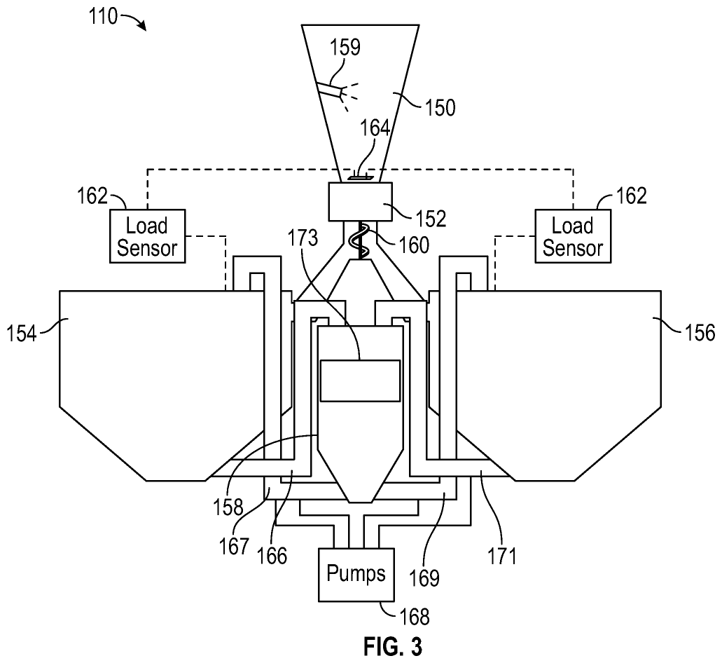

FIG. 3 schematically illustrates an alternative separation system 110, including a hopper 150 for receiving the plant material, a shredder mill 152 for grinding the plant material received in the hopper 150, a first agitation vessel 154 to receive the plant material from the shredder mill 152 and perform a first separation process with cryogenic fluid on the plant material, a second agitation vessel 156 to receive the plant material from the first agitation vessel 154 and perform a second separation process on the plant material, and a containment vessel 158 to receive the plant material from the second agitation vessel 156. In some examples, the system 110 can be used to process large amounts of plant material.

Plant material, such as cannabis or hops in some examples, are fed into the hopper 150. In some examples, a plant in its whole form can be entered into the hopper 150. One or more cryogenic fluid spray bars 159 may be positioned within the hopper feeder in some examples to spray cryogenic fluid on the plant material, which becomes frozen. Once frozen, the shredder mill 152 grinds the frozen plant material into smaller pieces. In some examples, a ¼ inch mill grinder is used to grind the frozen plant material into ¼ inch pieces. However, other size mill grinders can be used in other examples.

Once ground, the frozen plant material travels via an auger 160, located at the bottom of the shredder, to a designated agitation vessel, such as the first agitation vessel 154. Each of the agitation vessels 154/156 include one or more load sensors 162 to measure the weight of the frozen plant material moving from the shredder mill to the agitation vessel 154/156. In one embodiment, three load sensors 162 can be placed on each vessel. In some examples, once the load sensors 162 detect a predetermined weight of frozen plant material, a valve 164 located at the bottom of the hopper 150 automatically seals off the auger channel to the agitation vessel being filled to prevent additional plant material from moving into the vessel 154/156.

During the separation process in the first agitation vessel 154, cryogenic fluid may recirculate from the vessel 154 to the containment vessel 158 through fluid path 166 and back to the vessel 154 through fluid path 167. A containment basket or filter 173 is provided within the containment vessel 158 for containing the plant particulates before the cryogenic fluid passes back out of the containment vessel 158. In some examples, the basket 173 may be made from a mesh material, such as stainless steel, with a diameter of open space, between grids of the mesh material, between 0.1-10,000 microns. However, other diameter sizes of open space are possible.

When the agitation vessel 154 in which the plant material is located reaches a value of 1-target weight of plant material removal, the plant material and any separated components are transferred to the second agitation vessel 156, such as through the fluid path 166, then containment vessel 158, then fluid path 169 within cryogenic fluid, to undergo an additional separation process. Cryogenic fluid may then me recirculated between vessel 156 and containment tank 158 through fluid path 171, similarly to as it is done with the vessel 154. In some examples, the fluid paths 166, 167, 169, 171 are provided by stainless steel piping. In some examples, the stainless steel piping is 316L stainless steel piping. The fluid paths 166, 167, 169, 171 provide fluid communication between the vessels 154/156/158 and may utilize one or more fluid pumps 168 for producing fluid movement, as shown schematically. The separation process performed by the second agitation vessel 156 may be the same as, or different from, the separation process performed by the first agitation vessel 154.

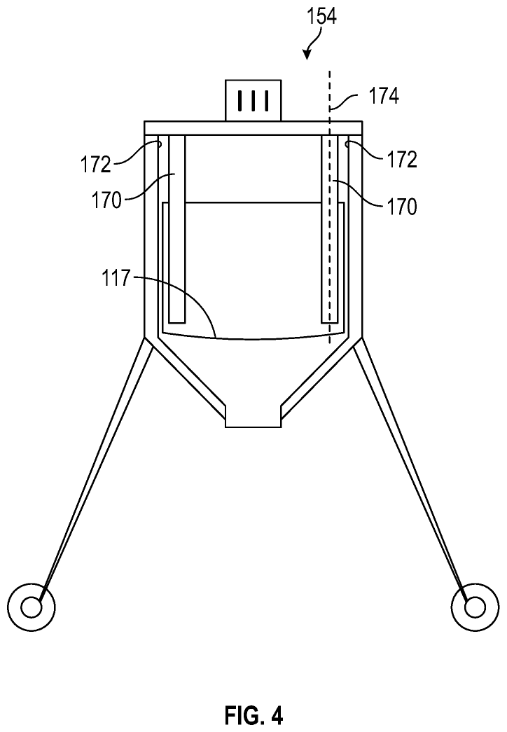

FIG. 4 illustrates an example agitation vessel 154. The frozen plant material is provided by the auger 160 (See FIG. 3) into a basket 117 within the agitation vessel 154 to perform separation of the plant material. It should be understood that like reference numerals identify corresponding or similar elements throughout the several drawings. In some examples, the separation process described above with respect to FIG. 2 can be performed. In some examples, the basket 117 may be made from a mesh material, such as stainless steel, with a diameter of open space, between grids of the mesh material, between 0.1-10,000 microns, depending on the plant material being processed. Other diameter sizes of open space are possible.

The example agitation vessel 154 may be similar to that shown in FIG. 1, with at least one difference being that that one or more spray bars 170, which act as baffles, may be used to spray cryogenic fluid on the frozen plant material and create turbulence to separate the plant material, such as the cannabinoids from other parts of the marijuana plant. The spray bars 170 create turbulent zones in which the material is agitated. As the cryogenic fluid encounters an object it begins a zone or turbulence within the vessel 154. The spray bars 170 can be oriented to be elongated vertically as shown within the agitation vessel 154 and spray the plant material the plant material within the basket 117. The example basket is provided radially between the surface 72 and the spray bars 170 so that the spray bars 170 can provide agitation within the basket 117. The environment inside the vessel 154, provided by the cryogenic fluid, helps solidify certain plant particulates, such as indumentums, and makes those particulates easily separable from the plant material, such as by reducing rupture due to the agitation and force of separation.

In some examples, the vessel 154 includes an inner surface 172 (two shown in FIG. 4), and four spray bars 170, one adjacent to each wall. More or fewer spray bars 170 may be utilized in some examples. In some examples, one or more of the spray bars 170 is rotatable about its central axis 174, to allow for varying spray directions to be utilized. For example, the spray bar 170 could be rotatable from positions where it sprays toward the center of the vessel 154, to positions where it sprays in a tangential direction with respect to the surface 172 (such as to create a vortex in the vessel 154), for optimizing the agitation needed for the plant material. In some examples, the spray bar 170 may be rotated to face the inner surface 172 to spray the wall 172, such as for cleaning. In some examples therefore, the spray bar 170 is rotatable from a first position oriented to spray toward the center of the vessel 154 to a second position oriented to spray at the inner surface 172 of the vessel 154. In some examples, the rotational angle between the first position and the second position is substantially 180 degrees (+/−20 degrees). The spray bar 170 may additionally or alternatively be rotated to another position in which it sprays substantially tangentially with respect to the inner surface 172, such as to create a vortex. The angle between this position and the first and second position is substantially 90 degrees (+/−20 degrees).

The cryogenic fluid emitted by the spray bars 170 is recirculated into the second agitation vessel 156 (see FIG. 3), such as through fluid paths 166, 169 via one or more transfer pumps 168. In some examples, the second agitation vessel 156 may be identical or substantially identical to the vessel 154. After the second separation process is complete, the separated plant material enters a guide shaft that pushes the plant material down a plunge seal into an auger and out of the second agitation vessel (not shown). The raw biomass, which is the component separated from the plant material, is transferred to the containment vessel 158, such as through fluid path 171, which may be configured similarly to fluid path 166, and subsequently removed from the separation system via an auger.

In some examples, the raw biomass may be further processed. In one embodiment, drying of the raw biomass may occur to ensure that the plant particulate has a moisture content of less than 10%. Additionally, refinement of the separated plant particulate may be performed prior to or after drying. Refinement may occur by passing the separated plant particulate through additional sieves or screens to isolate target plant components, performing a solvent extraction of the separated plant particulate, steaming the plant particulate, or performing a vacuum distillation. The separation process can be repeated using the same cryogenic fluid with new plant material.

In some examples, the agitation vessels 154/156 are each the same volume. In some examples, that volume is 2000 Liters. In some examples, the containment vessel has less volume than the agitation vessels 154/156. In some examples, the containment vessel is 300 Liters. Of course, other volumes may be utilized.

A method for cryogenic separation of plant material, such as in accordance with any of the examples disclosed, may include placing plant material into a hopper, grinding the plant material in a shredder mill, transferring the plant material from the shredder mill to a first agitation vessel, performing a first separation process with cryogenic fluid on the plant material in the first agitation vessel, transferring the plant material from the first agitation vessel to the second agitation vessel, and performing a second separation process with cryogenic fluid on the plant material in the second agitation vessel.

The method may further include transferring the plant material to a containment vessel and removing the plant material from the containment vessel. In some examples, the first separation process includes spraying the plant material with cryogenic fluid via at least one spray bar. In some examples, the spray bar is elongated vertically with respect to the first agitation vessel. In some examples, the spray bar extends along a central axis, the at least one spray bar is rotatable relative to the central axis to vary spray direction, and the first separation process includes rotating the at least one spray bar

While the invention has been particularly shown and described as referenced to the embodiments thereof, those skilled in the art will understand that the foregoing and other changes in form and detail may be made therein without departing from the spirit and scope.

Although the different examples are illustrated as having specific components, the examples of this disclosure are not limited to those particular combinations. It is possible to use some of the components or features from any of the embodiments in combination with features or components from any of the other embodiments.

The foregoing description shall be interpreted as illustrative and not in any limiting sense. A worker of ordinary skill in the art would understand that certain modifications could come within the scope of this disclosure. For these reasons, the following claims should be studied to determine the true scope and content of this disclosure.

What is claimed is:

1. A system for cryogenic separation of plant material, comprising:
a hopper for receiving the plant material;
a shredder mill for grinding the plant material received in the hopper;
a first agitation vessel configured to receive the plant material from the shredder mill and perform a first separation process with cryogenic fluid on the plant material;
a second agitation vessel configured to receive the plant material from the first agitation vessel and perform a second separation process on the plant material; and
a containment vessel configured to receive the plant material from the second agitation vessel.

2. The system as recited in claim 1, wherein the hopper includes a spray bar for spraying cryogenic fluid on the plant material.

3. The system as recited in claim 1, wherein the containment vessel includes a containment basket for containing plant particulates of the plant material.

4. The system as recited in claim 3, further comprising
one or more fluid paths between the containment vessel and first agitation vessel for recirculating the cryogenic fluid.

5. The system as recited in claim 1, further comprising
a fluid path for transferring plant material and cryogenic fluid from the first agitation vessel to containment vessel.

6. The system as recited in claim 5, further comprising
a second fluid path for transferring cryogenic fluid from the containment vessel to the first agitation vessel.

7. The system as recited in claim 6, further comprising
a third fluid path for transferring cryogenic fluid from the containment vessel to the second agitation vessel.

8. The system as recited in claim 1, further comprising
at least one spray bar within the first agitation vessel for spraying cryogenic fluid on the plant material.

9. The system as recited in claim 8, wherein the at least one spray bar elongated vertically with respect to the first agitation vessel.

10. The system as recited in claim 9, wherein the at least one spray bar extends along a central axis, and the at least one spray bar is rotatable relative to the central axis to vary spray direction.

11. The system as recited in claim 10, wherein the at least one spray bar is rotatable from a first position oriented to spray toward the center of the vessel to a second position oriented to spray at an inner wall of the vessel.

12. The system as recited in claim 11, wherein the at least one spray bar is rotatable from a third position oriented to spray in a direction substantially tangentially along the inner wall to the second position.

13. The system as recited in claim 10, wherein the at least one spray bar is rotatable from a first position oriented to spray in a direction along an inner wall of the vessel to a second position oriented to spray at the inner wall.

14. The system as recited in claim 8, wherein the at least one spray bar includes a plurality of spray bars.

15. The system as recited in claim 5, wherein the fluid path is provided by stainless steel piping.

16. The system as recited in claim 15, wherein the stainless steel piping is 316L stainless steel piping.

17. A method for cryogenic separation of plant material, the method comprising:
placing plant material into a hopper;
grinding the plant material in a shredder mill;
transferring the plant material from the shredder mill to a first agitation vessel;
performing a first separation process with cryogenic fluid on the plant material in the first agitation vessel;
transferring the plant material from the first agitation vessel to a second agitation vessel; and
performing a second separation process with cryogenic fluid on the plant material in the second agitation vessel.

18. The method as recited in claim 17, wherein the first separation process includes spraying the plant material with cryogenic fluid via at least one spray bar.

19. The method as recited in claim 18, wherein the at least one spray bar is elongated vertically with respect to the first agitation vessel.

20. The method as recited in claim 19, wherein the at least one spray bar extends along a central axis, the at least one spray bar is rotatable relative to the central axis to vary spray direction, and the first separation process includes rotating the at least one spray bar.
